(19) United States
(12) Patent Application Publication
(10) Pub. No.: US 2022/0246947 A1
(43) Pub. Date: Aug. 4, 2022

(54) HIGH ENTROPY ALLOY (HEA) ANODE FOR SOLID OXIDE FUEL CELL (SOFC)

(71) Applicant: UES, INC., Dayton, OH (US)

(72) Inventors: Rabi S. Bhattacharya, Dayton, OH (US); Oleg N. Senkov, Fairborn, OH (US); Prabhakar Singh, Storrs, CT (US)

(21) Appl. No.: 17/589,189

(22) Filed: Jan. 31, 2022

Related U.S. Application Data
(60) Provisional application No. 63/143,998, filed on Feb. 1, 2021.

(51) Int. Cl. H01M 4/90; H01M 8/12

(52) U.S. Cl. CPC H01M 4/9066; H01M 2008/1293; H01M 8/12

(57) ABSTRACT

A High Entropy Alloy (HEA) anode for a Solid Oxide Fuel Cell (SOFC), in which the HEA anode comprises: approximately ten (˜10) atomic percent (%) to ˜35% Copper (Cu) (preferably ˜23% to ˜27% Cu, and more preferably ˜24% to ˜26% Cu); ˜10% to ˜35% Iron (Fe) (preferably ˜23% to ˜27% Fe, and more preferably ˜24% to ˜26% Fe); ˜10% to ˜35% Cobalt (Co) (preferably ˜23% to ˜27% Co, and more preferably ˜24% to ˜26% Co); ˜5% to ˜25% Nickel (Ni) (preferably ˜13% to ˜17% Ni, and more preferably ˜14% to ˜16% Ni); ˜5% to ˜20% Manganese (Mn) (preferably ˜8% to 13% Mn, and more preferably ˜9% to 11% Mn); and less than a total of ˜2% other elements as impurities (preferably less than ˜1% total of other elements or impurities, and more preferably less than ˜0.5% total of other elements or impurities), with the sum of all of the alloying elements (Cu, Fe, Co, Ni, Mn, and impurities or other elements) totaling 100%.

### CROSS REFERENCE TO RELATED APPLICATIONS

This application claims the benefit of U.S. provisional patent application Ser. No. 63/143,998, filed 2021 Feb. 1, by UES, Inc., and having the title “High Entropy Alloy (HEA) Anode for Solid Oxide Fuel Cell (SOFC),” which is incorporated herein by reference in its entirety.

### STATEMENT REGARDING FEDERALLY SPONSORED RESEARCH OR DEVELOPMENT

This invention was made with government support under DOE STTR Phase II Award No. DE-SC0017050, MOD 0002 awarded by the Department of Energy. The government has certain rights in the invention.

### BACKGROUND

### Field of the Disclosure

The present disclosure relates generally to fuel cells and, more particularly, to systems and methods for manufacturing and using High Entropy Alloy (HEA) anodes for Solid Oxide Fuel Cells (SOFCs).

### Description of Related Art

Solid Oxide Fuel Cells (SOFCs) provide many advantages over traditional energy conversion systems including high efficiency, reliability, modularity, fuel adaptability, and very low levels of polluting emissions. Quiet, vibration-free operation of SOFCs also eliminates noise usually associated with conventional power generation systems, thereby making SOFCs beneficial over alternative energy conversion systems. Consequently, there are ongoing efforts to improve performance of SOFCs.

### SUMMARY

Briefly described, in architecture, one embodiment of the system comprises a High Entropy Alloy (HEA) anode for a Solid Oxide Fuel Cell (SOFC). The HEA anode comprises: approximately ten (˜10) atomic percent (%) to ˜35% Copper (Cu) (preferably ˜20% to ˜30% Cu, more preferably ˜23% to ˜27% Cu, and even more preferably ˜24% to ˜26% Cu); ˜10% to ˜35% Iron (Fe) (preferably ˜20% to ˜30% Fe, more preferably ˜23% to ˜27% Fe, and even more preferably ˜24% to ˜26% Fe); ˜10% to ˜35% Cobalt (Co) (preferably ˜20% to ˜30% Co, more preferably ˜23% to ˜27% Co, and even more preferably ˜24% to ˜26% Co); ˜5% to ˜25% Nickel (Ni) (preferably ˜10% to ˜20% Ni, more preferably ˜13% to ˜17% Ni, and even more preferably ˜14% to ˜16% Ni); ˜5% to ˜20% Manganese (Mn) (preferably ˜8% to ˜13% Mn, and more preferably ˜9% to ˜11% Mn); and less than a total of ˜2% other elements as impurities (preferably less than ˜1% total of other elements or impurities, and more preferably less than ˜0.5% total of other elements or impurities), with the sum of all of the alloying elements (Cu, Fe, Co, Ni, Mn, and impurities or other elements) totaling 100%.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram showing one embodiment of a Solid Oxide Fuel Cell (SOFC).

FIG. 2 is a table showing different embodiments of High Entropy Alloys (HEAs) with different compositions.

FIG. 3 is a chart showing one embodiment of methane (CH₄) reformation rate plotted as a function of methane flow rate for different catalysts.

FIG. 4 is a chart showing one embodiment of methane reformation rate plotted as a function of time for different catalysts.

FIG. 5 is a chart showing one embodiment of methanol (CH₃OH) reformation rate plotted as a function of time for different catalysts.

FIG. 6 is a chart showing one embodiment of Raman spectra after a reformation rate test for carbon deposits.

### DETAILED DESCRIPTION OF THE EMBODIMENTS

Direct Internal Reforming (DIR) is a process in which a given fraction of hydrocarbons (e.g., methane (CH₄) from natural gas, gasified biomasses, or coal gas), instead of hydrogen and carbon monoxide, is used directly as fuels by feeding the hydrocarbons straight to an anode side of a Solid Oxide Fuel Cell (SOFC). DIR-SOFCs have the potential to simplify fuel cells operating on hydrocarbons and significantly improve efficiency by avoiding losses associated with external reformers.

DIR-SOFCs typically require anode materials that have good catalytic reforming and electrochemical reactivity, such as Nickel-Yttria Stabilized Zirconia (Ni-YSZ), which has excellent catalytic properties and stability for Hydrogen (H₂) oxidation at the usual operation conditions. However, Carbon-containing fuels deposit large quantities of Carbon (C) on the surface of Nickel (Ni), thereby resulting in a marked and irreversible reduction in cell performance. Also, internal reforming operations sometimes lead to local subcooling around the entrance area of the electrochemically active anode section because of extremely fast kinetics of the reforming reactions, thereby resulting in mechanical failure due to thermally induced stresses.

To overcome some of the disadvantages associated with Ni-YSZ anodes, this disclosure provides a High Entropy Alloy (HEA) anode material, which are typically formed by mixing approximately equal or relatively large proportions of five (5) or more elements.

An HEA is oftentimes based on a multi-principal element alloy (MPEA), which comprises a base alloy with significant proportions of a few metal elements (e.g., two (2) or more base elements that may or may not be in substantially equal concentrations). Increasing the number of elements permits maximization of configurational entropy to improve stability of disordered solid solution (SS) phases, thereby suppressing formation of intermetallic (IM) phases. Specifically, the disclosed HEA comprises Cobalt (Co), Copper (Cu), Iron (Fe), Manganese (Mn), and Ni. The CoCuFeMnNi composite HEA replaces the Ni in Ni-YSZ or Gadolinium (Gd) doped Ceria (CeO₂) composite in the anode. In other words, the disclosed HEA ultimately replaces Ni in Ni-YSZ/GDC with HEA to form HEA-YSZ/GDC as the anode material for a DIR-SOFC. Thermodynamic calculations were performed on the CoCuFeMnNi composite to survey the phase diagram for a stable disordered face-centered cubic (FCC) phase at elevated temperatures. The CoCuFeMnNi composite showed a stable FCC phase at temperatures between approximately 1000° C. and approximately 1100° C.

Having provided a broad technical solution to a technical problem, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

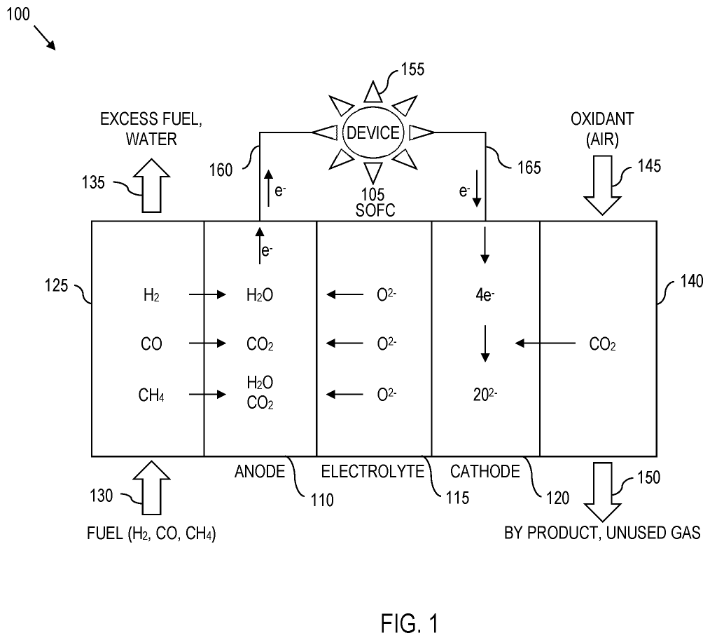

FIG. 1 is a schematic diagram showing basic elements in one embodiment of a solid oxide fuel cell (SOFC) 105. As shown in FIG. 1, the SOFC 105 comprises a porous anode 110 (or negative electrode), an electrolyte 115 in contact with the anode 110, and a porous cathode 120 (or positive electrode). As explained in greater detail, below, for some embodiments, the SOFC 105 comprises a HEA anode 110, with the HEA anode 110 comprising Cu, Fe, Co, Ni, and Mn.

Preferably, the respective atomic percent of the HEA is approximately ten (˜10) atomic percent (%) to ˜35% Copper (Cu) (preferably ˜20% to ˜30% Cu, more preferably ˜23% to ˜27% Cu, and even more preferably ˜24% to ˜26% Cu); ˜10% to ˜35% Iron (Fe) (preferably ˜20% to ˜30% Fe, more preferably ˜23% to ˜27% Fe, and even more preferably ˜24% to ˜26% Fe); ˜10% to ˜35% Cobalt (Co) (preferably ˜20% to ˜30% Co, more preferably ˜23% to ˜27% Co, and even more preferably ˜24% to ˜26% Co); ˜5% to ˜20% Nickel (Ni) (preferably ˜10% to ˜25% Ni, more preferably ˜13% to ˜17% Ni, and even more preferably ˜14% to ˜16% Ni); ˜5% to ˜20% Manganese (Mn) (preferably ˜8% to 13% Mn, and more preferably ˜9% to 11% Mn); and less than a total of ˜2% other elements as impurities (preferably less than ˜1% total of other elements or impurities, and more preferably less than ˜0.5% total of other elements or impurities), with the sum of all of the alloying elements (Cu, Fe, Co, Ni, Mn, and impurities or other elements) totaling 100%. In other words, the embodiment of FIG. 1 comprises an HEA-Yttria stabilized Zirconia (YSZ) anode, with the HEA replacing Ni from a conventional Ni-YSZ ceramic-metal composite (cermet) anode. As explained below, substituting HEA in place of Ni is neither trivial nor easy.

The main problem of DIR operation on a Ni-YSZ cermet anode is a mismatch between heat requirements for a steam reforming reaction (which is endothermic) and heat available from an oxidation of fuel (which is exothermic). At operating temperatures of the SOFCs, the kinetics of reforming reactions are extremely fast. Although the reforming reactions are limited by mass and heat transfer considerations, the rate of reforming reactions are nevertheless much higher than the corresponding fuel cell reactions. Consequently, internal reforming operations sometimes lead to local sub-cooling and inhomogeneous temperature distributions around the entrance area of the electrochemically active anode. This local sub-cooling induces thermal stresses that sometimes produce mechanical failures.

Furthermore, hydrocarbon reactions on Ni produce carbon deposits on the anode, which create additional problems. This carbon formation results in pulverization of the anode over time and deactivation of the anode material, which in turn leads to deterioration of fuel cell performance. DIR also suffers from potential introduction of impurities (e.g., Sulfur) in the feed fuel or by sintering of the active metal at high temperatures.

Next, in the context of Ni-YSZ, the Ni causes some other significant problems. First, Ni catalyzes the formation of graphitic carbon in hydrocarbon atmospheres and, thus, limits fuel choice to hydrogen (H₂) and carbon dioxide (CO₂) for Ni-YSZ cermet anodes. Second, Ni is unstable in oxidation-reduction cycling and accidental oxidation of Ni to form Nickel oxide (NiO₂) causes a large lattice expansion, thereby leading to mechanical failures in the SOFC. Third, Sulfur (S) and other impurities in the gas feed also react with Ni and degrade the performance of the Ni-YSZ anode.

Others have attempted to ameliorate the drawbacks associated with Ni by substituting Cu for Ni. However, Cu is thermally unstable due to its low melting point, which approaches the operating temperatures of SOFCs. Other materials, such as Ceria (either doped or undoped) have lower susceptibility to coking or S contamination. However, materials such as Samaria-doped Ceria (SDC) have electrical conductivities that are several orders of magnitude lower than Ni and, thus, cannot effectively replace Ni. Moreover, impregnation of Ceria into cermet anodes is both difficult and costly. As one of skill in the art can appreciate, it is not a trivial task to find an anode material that: (a) is resistant to coking; (b) has sufficient electrochemical activity; and (c) has suitable electrical conductivity. Also, the resulting behavior when Ni is replaced with another material is not always predictable.

Continuing with FIG. 1, the electrolyte 115 is positioned between the HEA anode 110 and the cathode 120. Fuel 125 is input 130 at the HEA anode 110 and flows along the surface of the HEA anode 110. Excess fuel 135 that is not consumed at the HEA anode 110 is expelled. At the cathode 120, an oxidant 140 (e.g., air) is input 145 and flows along the surface of the cathode 120. Unused oxidant 150 or any byproduct of the oxidation reaction is expelled. An electrical device 155 that is connected to the SOFC 105 through conducting leads 160, 165 receives current from the SOFC 105. Theoretically, an SOFC 105 is able to produce electricity for as long as fuel 125 and oxidant 140 are supplied to the HEA anode 110 and cathode 120, respectively.

As shown in FIG. 1, by combining Cu, Fe, Co, Mn, and Ni to form a HEA, and then using the HEA to make a cermet with YSZ for SOFC anodes, the HEA-YSZ/GDC anode 110 lowers the reformation rate and avoids subcooling around the HEA anode 110, thus preventing mechanical failure due to thermal stresses. Another advantage of the HEA-YSZ/GDC anode 110 is that carbon deposition is totally avoided, as explained in greater detail, below.

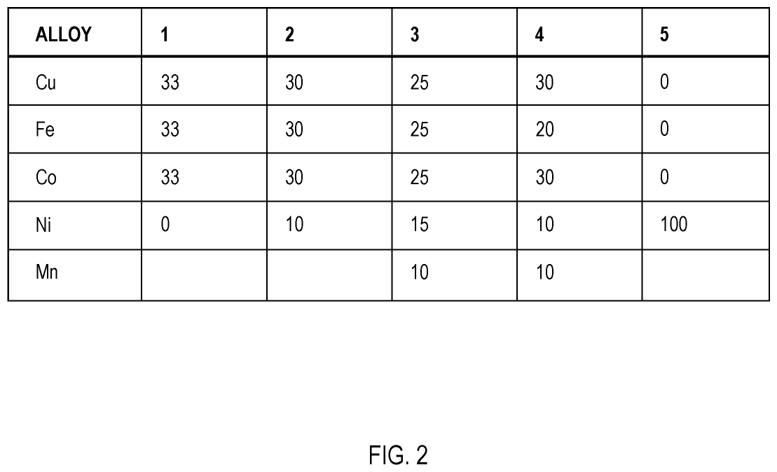

Having describe an example embodiment of an SOFC 105 with a HEA anode 110, attention is turned to FIGS. 2 through 6, which show testing results for the HEA anode 110 of FIG. 1.

Certain Ni-based alloys (e.g., Ni₄Fe and Ni₄Mn) have better catalytic characteristics and coking resistance than pure Ni. Recent modeling results show that the reaction energy barrier for the rate-determining step for CH→C+H for Ni₄Fe and Ni₄Mn is smaller than that of pure Ni. Also, the binding energy of C is approximately ten kilocalories per mol (˜10 kcal/mol) lower for the Ni₄Fe and Ni₄Mn alloys, as compared to pure Ni. Thus, in addition to Ni, Fe and Mn are desirable elements for a catalyst that is coking resistant. Additionally, Co is useful in methanol oxidation and Cu is resistant to coking while having high electrical conductivity. Thus, Cu in a solid solution (SS) alloy with other desirable elements increases its stability at higher temperatures.

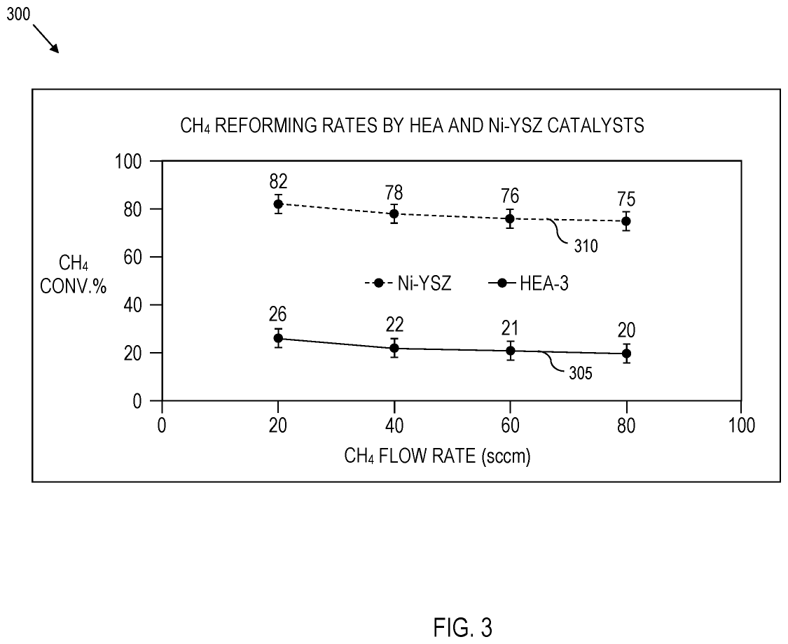

With this in mind, thermodynamic calculations were performed to determine composition ranges for SS CoFeMn, CoCuFeMn, and NiCoCuFeMn alloys. Thereafter, selected alloys were fabricated, as shown in FIG. 2, by conventional powder synthesis and thin film by magnetron sputter deposition approaches. Specifically, as shown in FIG. 2, the alloys selected for feasibility demonstrations included: ˜33 atomic percent (%) Cu, ˜33% Fe, and ˜33% Co (Cu₃₃Fe₃₃Co₃₃, labeled as Alloy1); Cu₃₀Fe₃₀Co₃₀Ni₁₀ (Alloy2); Cu₂₅Fe₂₅Co₂₅Ni₁₅Mn₁₀ (Alloy3); Cu₃₀Fe₂₀Co₃₀Ni₁₀Mn₁₀ (Alloy4); and Ni (Alloy5, which forms the conventional Ni-YSZ/GDC anode). Of these, Alloy3 (Cu₂₅Fe₂₅Co₂₅Ni₁₅Mn₁₀ HEA) was compared to Alloy5 (Ni only) and the results of the comparison are shown with reference to FIGS. 3 through 6.

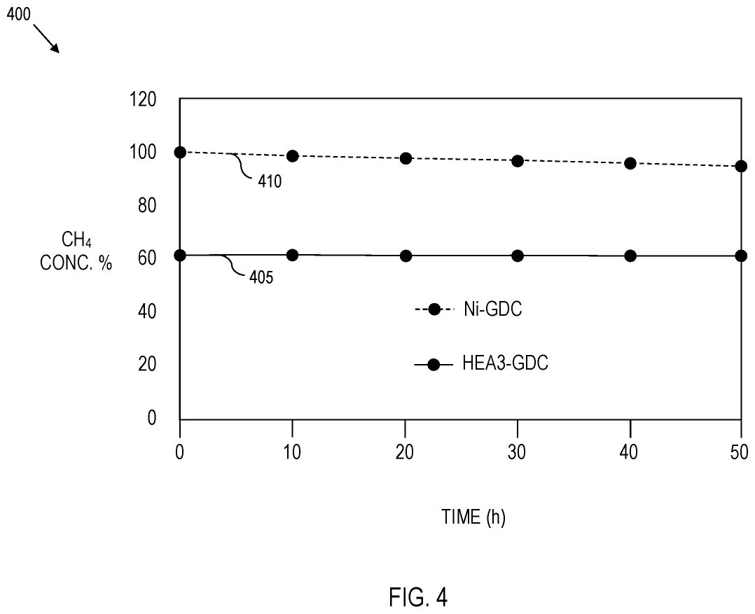

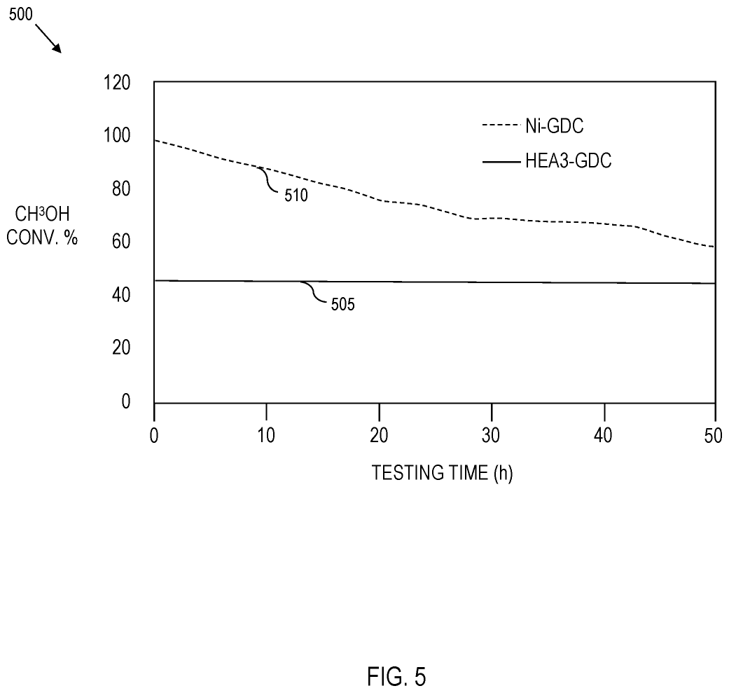

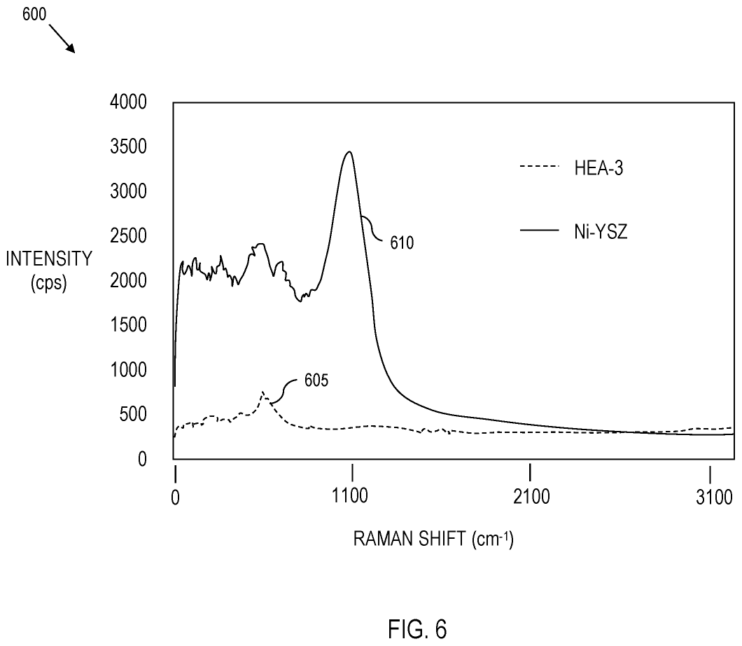

Specifically, HEA-YSZ/GDC (Alloy3) and Ni-YSZ/GDC (Alloy5) were tested in a CH₄/steam reformer and CH₃OH/steam reformer at 750° C. As shown in FIG. 3, CH₄ reformation rate (y-axis) at 750° C. was plotted as a function of CH₄ flow rate (in standard cubic centimeters per minute (secm), x-axis) for both Alloy3 305 and Ni-YSZ/GDC (Alloy5) 310. The steam-to-CH₄ molar ratio was 3.0 for FIG. 3. In FIG. 4, CH₄ reformation rate (y-axis) at 750° C. was plotted as a function of time (in hours (h), x-axis) for both HEA-YSZ/GDC (Alloy3) 405 and Ni-YSZ/GDC (Alloy5) 410. FIG. 5 shows the CH₃OH reformation rate (y-axis) at 750° C. was plotted as a function of time (h, x-axis) for both HEA-YSZ/GDC (Alloy3) 505 and Alloy5 510. Lastly, FIG. 6 shows Raman spectra for HEA-YSZ/GDC (Alloy3) 605 and Ni-YSZ/GDC (Alloy5) 610 after a reformation rate test for carbon deposits.

As shown in FIGS. 3 through 6, the CH₄ and CH₃OH reforming rates on HEA-YSZ/GDC (Alloy3) were lower than on conventional Ni-YSZ/GDC (Alloy5), and the microstructures of the designed HEAs remained stable. Scanning electron microscopy-energy dispersive spectroscopy (SEM-EDS) and Raman spectroscopy found no carbon formation in post-test Cu₂₅Fe₂₅Co₂₅Ni₁₅Mn₁₀ (Alloy3). X-ray diffraction (XRD) analysis of magnetron sputtered coatings similar to Cu₂₅Fe₂₅Co₂₅Ni₁₅Mn₁₀ (Alloy3) showed phases that matched our calculations.

As shown and described herein, by combining Cu, Fe, Co, Mn, and Ni to form a HEA, and then using the HEA to make a cermet with YSZ for SOFC anodes, the HEA-YSZ/GDC anode 110 lowers the reformation rate and avoids subcooling around the HEA-YSZ/GDC anode 110, thus preventing mechanical failure due to thermal stresses. The HEA-YSZ/GDC anode 110 further avoids carbon deposition, which is problematic with conventional Ni-YSZ/GDC anodes.

Any process descriptions or blocks in flow charts should be understood as steps in a process, and alternate implementations are included within the scope of the preferred embodiment of the present disclosure in which steps may be executed out of order from that shown or discussed, including substantially concurrently or in reverse order, depending on the functionality involved, as would be understood by those reasonably skilled in the art of the present disclosure.

Although exemplary embodiments have been shown and described, it will be clear to those of ordinary skill in the art that a number of changes, modifications, or alterations to the disclosure as described may be made. For example, although the atomic percent of ˜25 is shown and described for Cu, those having skill in the art will appreciate that the atomic percent of Cu can range from ˜5% to ˜35%. Similarly, Fe has an operable range of ˜5% to ˜35% (atomic percent); Co has an operable range of ˜5% to ˜35% (atomic percent); Ni has an operable range of ˜5% to ˜25% (atomic percent); and Mn has an operable range of ˜5% to ˜20% (atomic percent). In other words, as long as the total atomic percent totals 100%, with impurities not exceeding ˜1% (atomic percent), those having skill in the art will understand that one component of the HEA may be increased or decreased, with a corresponding decrease or increase in another HEA component. It should be appreciated that, for some embodiments, a CoCuFeMN alloy shows a stable FCC phase at temperatures between approximately 1000° C. and approximately 1075° C. and that CoCuFeMn alloys are reasonably predicted to have comparable performances.

All such changes, modifications, and alterations should therefore be seen as within the scope of the disclosure.

What is claimed is:

1. In a solid oxide fuel cell (SOFC), an anode comprising a high-entropy alloy (HEA), the HEA comprising:
approximately ten (˜10) atomic percent (%) to ˜35% Copper (Cu);
˜10% to ˜35% Iron (Fe);
˜10% to ˜35% Cobalt (Co);
˜5% to ˜25% Nickel (Ni);
˜5% to ˜20% Manganese (Mn); and
less than ˜2% other elements or impurities, wherein a sum of the atomic percent of the Cu, Fe, Co, Ni, Mn, and other elements or impurities total 100%.

2. The anode of claim 1, wherein:
the atomic percent of Cu in the HEA is between ˜20% and ˜30%;
the atomic percent of Fe in the HEA is between ˜20% and ˜30%;
the atomic percent of Co in the HEA is between ˜20% and ˜30%;
the atomic percent of Ni in the HEA is between ˜10% and ˜20%; and
the atomic percent of Mn in the HEA is between ˜5% and ˜15%.

3. The anode of claim 1, wherein:
the atomic percent of Cu in the HEA is between ˜23% and ˜27%;
the atomic percent of Fe in the HEA is between ˜23% and ˜27%;
the atomic percent of Co in the HEA is between ˜23% and ˜27%;
the atomic percent of Ni in the HEA is between ˜13% and ˜17%; and
the atomic percent of Mn in the HEA is between ˜8% and ˜13%.

4. The anode of claim 1, wherein:
the atomic percent of Cu in the HEA is between ˜24% and ˜26%;
the atomic percent of Fe in the HEA is between ˜24% and ˜26%;
the atomic percent of Co in the HEA is between ˜24% and ˜26%;
the atomic percent of Ni in the HEA is between ˜14% and ˜16%; and
the atomic percent of Mn in the HEA is between ˜9% and ˜11%.

5. The SOFC of claim 1, wherein the amount of other elements or impurities in the HEA is insignificant.

6. The SOFC of claim 1, wherein the amount of other elements or impurities in the HEA is less than ˜1% of the total atomic percent.

7. The SOFC of claim 1, wherein the amount of other elements or impurities in the HEA is less than ˜0.5% of the total atomic percent.

8. A solid oxide fuel cell (SOFC) comprising:
a cathode for reacting with an oxidant;
an anode for reacting with a fuel, the anode comprising:
a high-entropy alloy (HEA), the HEA comprising:
approximately ten (˜10) atomic percent (%) to ˜35% Copper (Cu);
˜10% to ˜35% Iron (Fe);
˜10% to ˜35% Cobalt (Co);
˜5% to ˜25% Nickel (Ni);
˜5% to ˜20% Manganese (Mn); and
less than ˜2% other elements or impurities, wherein a sum of the atomic percent of the Cu, Fe, Co, Ni, Mn, and other elements or impurities total 100%.
an electrolyte disposed between the cathode and the anode.

9. The SOFC of claim 8, wherein:
the atomic percent of Cu in the HEA is between ˜20% and ˜30%;
the atomic percent of Fe in the HEA is between ˜20% and ˜30%;
the atomic percent of Co in the HEA is between ˜20% and ˜30%;
the atomic percent of Ni in the HEA is between ˜10% and ˜20%; and
the atomic percent of Mn in the HEA is between ˜5% and ˜15%.

10. The SOFC of claim 8, wherein:
the atomic percent of Cu in the HEA is between ˜23% and ˜27%;
the atomic percent of Fe in the HEA is between ˜23% and ˜27%;
the atomic percent of Co in the HEA is between ˜23% and ˜27%;
the atomic percent of Ni in the HEA is between ˜13% and ˜17%; and
the atomic percent of Mn in the HEA is between ˜8% and ˜13%.

11. The SOFC of claim 8, wherein:
the atomic percent of Cu in the HEA is between ˜24% and ˜26%;
the atomic percent of Fe in the HEA is between ˜24% and ˜26%;
the atomic percent of Co in the HEA is between ˜24% and ˜26%;
the atomic percent of Ni in the HEA is between ˜14% and ˜16%; and
the atomic percent of Mn in the HEA is between ˜9% and ˜11%.

12. The SOFC of claim 8, wherein the atomic percent of the other elements or impurities in the HEA is insignificant.

13. The SOFC of claim 8, wherein the atomic percent of the other elements or impurities in the HEA is less than ˜1% of the total atomic percent.

14. The SOFC of claim 8, wherein the atomic percent of the other elements or impurities in the HEA is less than ˜0.5% of the total atomic percent.

15. A high-entropy alloy (HEA) for use an anode of a solid oxide fuel cell (SOFC), the HEA comprising:
approximately ten (˜10) atomic percent (%) to ˜35% Copper (Cu);
˜10% to ˜35% Iron (Fe);
˜10% to ˜35% Cobalt (Co);
˜5% to ˜25% Nickel (Ni);
˜5% to ˜20% Manganese (Mn); and
less than ˜2% other elements or impurities, wherein a sum of the atomic percent of the Cu, Fe, Co, Ni, Mn, and other elements or impurities total 100%.

16. The HEA of claim 15, wherein:
the atomic percent of Cu is between ˜20% and ˜30%;
the atomic percent of Fe is between ˜20% and ˜30%;
the atomic percent of Co is between ˜20% and ˜30%;
the atomic percent of Ni is between ˜10% and ˜20%; and
the atomic percent of Mn is between ˜5% and ˜15%.
the atomic percent of the other elements or impurities is less than ˜1% of the total atomic percent.

17. The HEA of claim 15, wherein:
the atomic percent of Cu is between ˜23% and ˜27%;
the atomic percent of Fe is between ˜23% and ˜27%;
the atomic percent of Co is between ˜23% and ˜27%;
the atomic percent of Ni is between ˜13% and ˜17%;
the atomic percent of Mn is between ˜8% and ˜13%; and
the atomic percent of the other elements or impurities is less than ˜0.5% of the total atomic percent.

18. The HEA of claim 15, wherein:
the atomic percent of Cu is between ˜24% and ˜26%;
the atomic percent of Fe is between ˜24% and ˜26%;
the atomic percent of Co is between ˜24% and ˜26%;
the atomic percent of Ni is between ˜14% and ˜16%;
the atomic percent of Mn is between ˜9% and ˜11%; and
the atomic percent of the other elements or impurities is insignificant.
